(19) United States
(12) Patent Application Publication
(10) Pub. No.: US 2011/0064036 A1
(43) Pub. Date: Mar. 17, 2011

(54) METHOD AND ARRANGEMENT FOR IMPROVED RADIO RESOURCE ALLOCATION IN A MIMO SYSTEM

(76) Inventors: Shiau-He Tsai, San Deigo, CA (US); Lei Wan, Beijing (CN)

(21) Appl. No.: 12/666,842

(22) PCT Filed: Nov. 30, 2007
(86) PCT No.: PCT/SE2007/050928

§ 371 Date: Apr. 29, 2010

Related U.S. Application Data
(60) Provisional application No. 60/929,431, filed on Jun. 27, 2007.

(51) Int. Cl. H04W 72/04

(52) U.S. Cl. 370/329

(57) ABSTRACT

In a method for improved HARQ retransmissions of data streams in a node in a MIMO wireless communication system, transmitting S1 data across a plurality of available MIMO links according to a predetermined rank and radio resource allocation, receiving S2 a retransmission request for at least part of the transmitted data, reducing the rank S3 of the retransmissions by selecting a subset of the plurality of available MIMO links. Subsequently, adaptively reallocating S4 available radio resources to the selected subset, and retransmitting S5 the requested data on said selected subset according to the reduced rank and radio resource re-allocation.

### TECHNICAL FIELD

The present invention relates to wireless communication systems in general, and specifically to improved resource allocation in a multiple-input multiple-output wireless communication system.

### BACKGROUND

In a wireless communication system, a transmitter (e.g. a base station, or a terminal) may utilize multiple transmit antennas for data transmission to a receiver equipped with multiple receive antennas. The multiple transmit- and receive antennas form a Multiple-Input Multiple-Output (MIMO) channel that may be used to increase throughput and/or improve reliability. For example, the transmitter may transmit a number of data streams simultaneously from the transmit antennas to improve throughout. Alternatively, the transmitter may transmit a single data stream redundantly from all transmit antennas to improve reception by the receiver. Another common term for this technology is smart antennas, which performs spatial information processing with multiple antennas. MIMO systems offer significant increases in data throughput and link range without additional bandwidth or transmit power for wireless communications. This is achieved by higher spectral efficiency (more bits per second per Hertz of bandwidth) and link reliability or diversity (reduced fading).

For wireless communications, MIMO systems provide an extra signal space dimension in addition to frequency and time. Dedicated transmit- and receive-antenna pairs create ranks of the spatial dimension, e.g. the rank is representative of the number of data streams that can be transmitted simultaneously via the MIMO channel. If too many data streams are sent, then excessive interference may be observed by each of these data streams and the overall performance may suffer. Conversely, if too few data streams are sent, then the capacity of the MIMO channel is not fully utilized. Ideally, each link of the MIMO transmit-receive antenna pairs occupies one rank in the signal space such that channel coefficients form a full-rank matrix. A MIMO receiver can then use signal-processing techniques to separate signals from different antennas that are overlapped in frequency and time by their linear independence in the spatial dimension. The separation of signals is similar to insulated wires, with the only exception that it is accomplished through the common wireless medium of the same frequency and time. With this extra spatial dimension created by MIMO, multiple data streams can be superposed on one another over the air, thereby increasing the supportable data rate.

Multiple retransmission schemes are disclosed in prior art. One commonly used scheme is so-called Automatic Repeat reQuest (ARQ), which is an error control technique for data transmissions, which makes use of acknowledgements and timeouts to achieve reliable data transmission. An evolved variant of ARQ is the so-called Hybrid-ARQ or H-ARQ, which optimally gives better performance over ordinary ARQ on wireless channels.

H-ARQ is frequently utilized as a remedy for link adaptation error or as a mechanism for interference reduction by opportunistic early termination. Due to unpredictable fading in wireless mobile environments, the MIMO channel might have non-negligible changes between the time of being scheduled and the time of reporting. The mismatch in reporting and scheduling may result in selecting overly optimistic modulation and coding schemes that the link can support, hence causing packet errors. Without H-ARQ, the residual packet errors in the physical layer can only be corrected by upper layer protocols. With H-ARQ, the physical layer is able to quickly respond to retransmit the packet for a second chance.

For the uplink, dividing the required energy for a packet to several transmissions will reduce the power, hence interference, fluctuation. H-ARQ can take advantage of possible early termination of an uplink packet to harvest the opportunistic gain. H-ARQ is expected to provide the same benefits for MIMO systems.

Therefore, there is a need for a method and arrangement enabling improved efficiency for HARQ retransmissions in MIMO systems.

### BRIEF DESCRIPTION OF THE DRAWINGS

The invention, together with further objects and advantages thereof, may best be understood by referring to the following description taken together with the accompanying drawings, in which:

FIG. 1 illustrates the principles of known MIMO signaling FIG. 2a illustrates a general wireless system;

FIG. 2b illustrates a schematic generalized MIMO system;

FIG. 3 illustrates a schematic flow diagram of a general embodiment of a method according to the present invention;

FIG. 4a illustrates schematically the principle of vertical coding;

FIG. 4b illustrates schematically the principle of horizontal coding;

FIG. 5 illustrates a schematic block diagram of an arrangement according to the present invention;

### ABBREVIATIONS

### ACK ACKnowledgement

### CDMA Code Division Multiple Access

### CRC Cyclic Redundancy Check

CQI Channel quality information
H-ARQ Hybrid Automatic Repeat reQuest

### MIMO Mutiple-Input Multiple-Output

### NACK Negative ACKnowledgement

### OFDM Orthogonal Frequency Division Multiplexing

### PUSC Partial Usage of Sub-Carrier

### SIMO Single-Input Multiple-Output

### WCDMA Wideband Code Division Multiple Access

### DETAILED DESCRIPTION

To provide ample understanding of relevant concepts of the present invention, a general description of the theory of multiple-input multiple-output system signals will follow below.

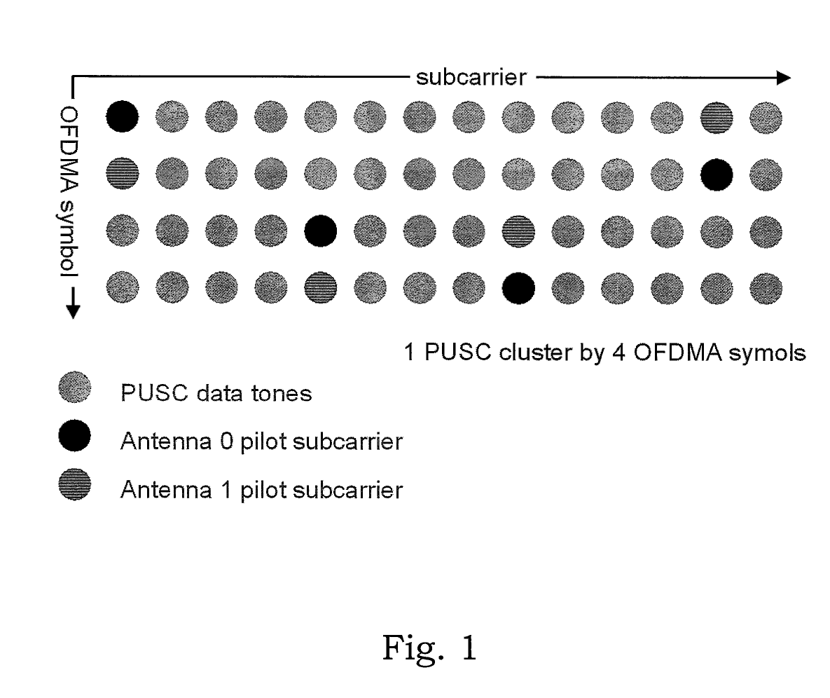

Generally, the spatial signature of signals in a MIMO system can be extracted from the pilots or pilot signals. For example, the pilots of different antennas can be designed to be orthogonal in time and frequency domain. A 2×2 MIMO example of the 802.16e [1] is illustrated in FIG. 1. Consequently, the example assumes a system comprising two transmit/receive antenna pairs i.e. two transmit antennae and two receive antennae. Accordingly, a signal is illustrated as a Partial Usage of Sub-Carrier (PUSC) cluster comprising four Orthogonal Frequency Division Multiplexing (OFDM) symbols and their separate pilots and their separation in time (OFDMA symbol) and frequency (subcarrier).

In FIG. 1, a receiver can derive the 2×1 channel vector h₀=[h_{0,0} h_{0,1}]^{T} at Antenna 0 from the solid black dots, and the channel vector h₁=[h_{1,0} h_{1,1}]^{T} for Antenna 1 from the stripped dots, where the first digit in the subscript denotes the transmit antenna number and the second denotes the receive antenna number. Assume the data symbol transmitted by Antenna 0 is x₀ and the one by Antenna 1 is x₁, then at the two receive antennae, the observation can be expressed by Equation 1

$$‖ \begin{matrix}{y}_{0} \\ {y}_{0}\end{matrix} ‖ = [ \begin{matrix}{h}_{0 , 0} & {h}_{1 , 0} \\ {h}_{0 , 1} & {h}_{1 , 1}\end{matrix} ] ‖ \begin{matrix}{x}_{0} \\ {x}_{1}\end{matrix} ‖ + [ \begin{matrix}{n}_{0} \\ {n}_{1}\end{matrix} ] \qquad ( 1 )$$

where n₀ and n₁ are the noise and interference samples observed at receive Antennae 0 and 1. Looking at Equation 1, if noise components can be ignored and assume the channel coefficient matrix is full-rank, it can be solved for the two unknowns x₀ and x₁ based on the two observations y₀ and y₁. In practice, when noise components are not negligible, a noise variance matrix is usually added to the inverse of the channel coefficient matrix for the minimum mean-squared-error solution of the data symbols.

The above example can be easily generalized to M×N MIMO systems, where M is the number of transmitted symbols in spatial domain of a MIMO codeword and N the number of received MIMO symbol observations. Note that the MIMO pilot in the example of FIG. 1 is not only restricted to frequency and time domain. Indeed, the horizontal and the vertical axes can be any dimensions of the signal space, which include time, frequency or code, as long as channel coefficients in the signal space can be estimated from pilots with practical filters. Thus, the equation is written in a general sense as

$$‖ \begin{matrix}{y}_{0} \\ ⋮ \\ {y}_{N - 1}\end{matrix} ‖ = [ \begin{matrix}{h}_{0 , 0} & ⋯ & {h}_{0 , M - 1} \\ ⋮ & ⋱ & ⋮ \\ {h}_{N - 1 , 0} & ⋯ & {h}_{N - 1 , M - 1}\end{matrix} ] [ \begin{matrix}{v}_{0 , 0} & ⋯ & {v}_{0 , M - 1} \\ ⋮ & ⋱ & ⋮ \\ {v}_{N - 1 , 0} & ⋯ & {v}_{N - 1 , M - 1}\end{matrix} ] ‖ \begin{matrix}{x}_{0} \\ ⋮ \\ {x}_{M - 1}\end{matrix} ‖ + [ \begin{matrix}{n}_{0} \\ ⋮ \\ {n}_{N - 1}\end{matrix} ] \qquad ( 2 )$$

where

$$[ \begin{matrix}{v}_{0 , 0} & ⋯ & {v}_{0 , M - 1} \\ ⋮ & ⋱ & ⋮ \\ {v}_{N - 1 , 0} & ⋯ & {v}_{N - 1 , M - 1}\end{matrix} ]$$

is the precoding matrix at the transmitter. For those non-precoded systems where N is equal to M, the precoding matrix is an identity matrix.

The rank of the channel coefficient matrix is less than or equal to min(M,N). As long as the number of code words is less than the rank, the simultaneous equation has a unique solution. The parallel data streams multiplexed in the generalized temporal-spectral-and-spatial domain can increase the peak rate of the MIMO system if the channel coefficient matrix is full-rank. In summary, the instantaneous realization of wireless channel and noise must result in separable signal space components such that a unique solution exists for the multiplexed data streams.

In parallel, the spatial diversity, such as Alamuti-code or SFBC, also relies on the multi-rank channels to improve coverage. The spatial diversity reaches good performance at the uncorrelated channels among different antenna branches, but is much worse than the single-antenna transmission at the strongly correlated channels.

The transmitted data symbols in the aforementioned equations may not be correctly solved if the noise-and-interference level is too high compared to the signal part, or can be completely unsolvable if the channel coefficient matrix is not full-rank due to changing characteristic of wireless propagation. Also, the failure of the initial detection of [x₀ x₁] may be caused by excessive channel estimation error. For the system with interference cancellation at the receiver, the error propagation will result to complete failure of all the transmitted codewords. Under these scenario, the afore mentioned H-ARQ scheme is of very limited help because it is only designed to provide energy or coding gain, not to provide extra signal space dimensions to separate multiplexed signals or suppress excessive interferences. Thus, there is a need for improving the applicability of H-ARQ to MIMO systems.

One prior art in this field is to reduce the rank of MIMO for H-ARQ retransmissions [2]. The reduced rank makes a MIMO system more robust against channel estimation and interference cancellation errors, especially in the strongly correlated channels. However, the prior art only introduced the rank reduction mechanism for spatial multiplexing. With a different number of MIMO ranks during retransmission, the corresponding radio resource allocation schemes remain the same as the initial transmission. Consequently, if conditions are the same for the retransmission attempt as for the initial transmission in an interference heavy environment, then the likelihood of success of the H-ARQ is limited.

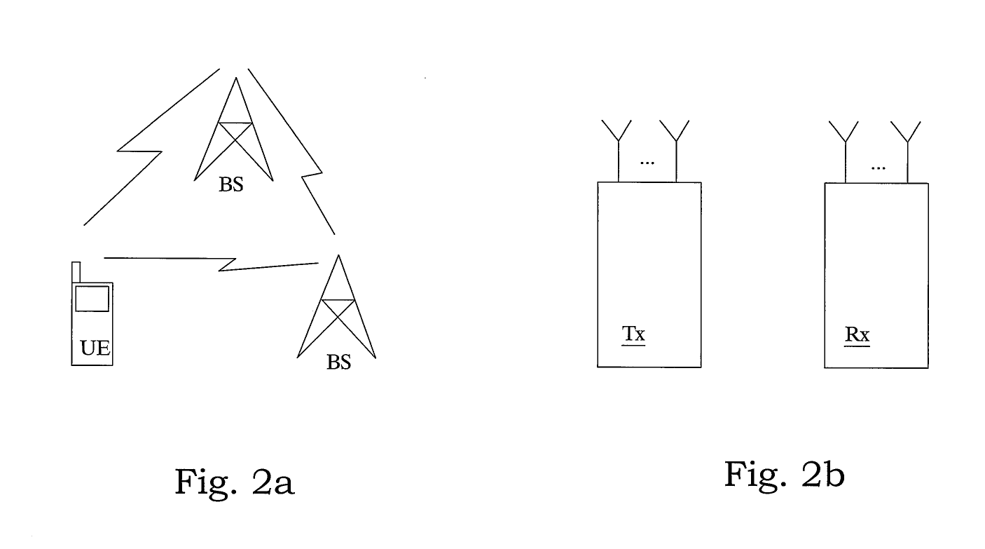

The present invention will be described below with reference to the very general wireless system illustrated in FIG. 2a and the MIMO system of FIG. 2b.

Accordingly, the system in FIG. 2a is a wireless communication system. The system comprises a plurality of base stations BS in one or more sectors that receive, transmit, repeat etc. wireless communication signals to each other and/or to one or more user equipment UE. Each base station BS can comprise a transmitter chain and a receiver chain, each of which can in turn comprise a plurality of components associated with signal transmission and reception (e.g. processors, modulators, multiplexers, demodulators, demultiplexers, antennas etc). User equipment UE can be for example cellular phones, smart phones, laptops, handheld communication devices, handheld computing devices, satellite radios, global positioning systems, PDAs, and/or other suitable device for communicating over the wireless network.

In addition, FIG. 2b visualizes a general MIMO system where some transmitting device TX comprising multiple antennas or antenna groups is in wireless communication with a receiving device RX comprising multiple antennas or antenna groups. The skilled person realizes that each of the transmitting Tx and the receiving device Rx can be adapted as transceivers with both transmitting and receiving antennas.

The present invention will mainly be discuss in the context of a wireless communication system utilizing OFDM, but it is appreciated that the same general ideas are fully adaptable to systems utilizing CDMA or WCDMA or similar.

A basic aspect of a method of the present invention is thus to allocate the radio resource in a flexible way during the reduced rank MIMO HARQ retransmission. In essence, according to a basic embodiment, upon receiving a H-ARQ the transmitter reduces the rank of the MIMO channel by selecting a subset of the available MIMO links to retransmit the requested data, not necessarily the originally allocated links and re-allocates the available radio resources to improve the H-ARQ retransmission performance.

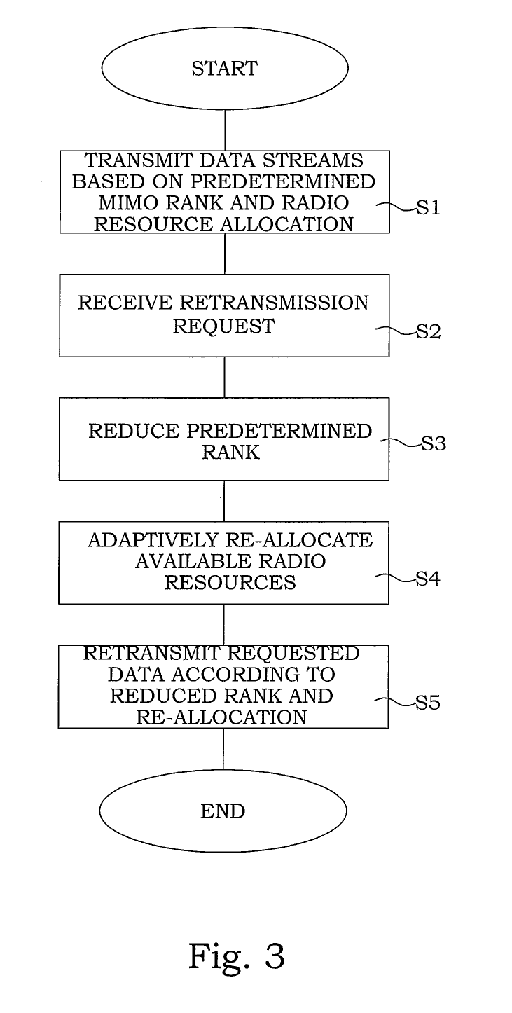

Particular, with reference to FIG. 3, a general embodiment of a method according to the present invention enables improved H-ARQ retransmissions in a node in a MIMO wireless communication system, e.g. OFDM based. However, the present invention is equally applicable to a system utilizing CDMA or WCDMA or similar Initially data is transmitted S1 across a plurality of available MIMO links based on a predetermined rank and radio resource allocation. In response to receiving a H-ARQ S2 for at least part of the transmitted data the rank of the subsequent retransmissions is reduced S3 by selecting a subset of the available MIMO links, including the links that are once again available due to successful transmissions. In addition, the available radio resources are re-allocated S4 in a flexible or adaptive manner to further increase the chance of successful retransmission of the requested data. Finally, the requested data is retransmitted S5 according to the selected subset of MIMO links, e.g. reduced rank MIMO channel, and the re-allocated radio resources.

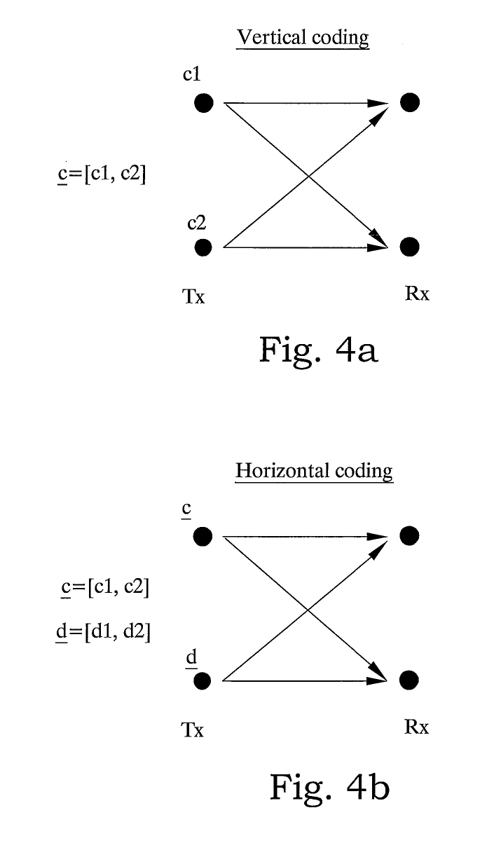

It should be noted, with reference to FIG. 4a and FIG. 4b, that for MIMO systems the data streams to be transmitted can be subjected to either of vertical or horizontal coding. Accordingly, as shown in FIG. 4a, for vertical coding the different symbols c1, c2 of a data stream c are transmitted over different MIMO links originating in different Tx antennas. Similarly, as shown in FIG. 4b, for horizontal coding the symbols comprising two data streams c and d are transmitted over different MIMO links, the two data streams also being transmitted from different Tx antennas.

The ACK/NACK feedback for MIMO HARQ data streams can be sent in a separate or an aggregate fashion. For horizontal coding, both per stream HARQ and per-transmission time interval HARQ are feasible.

The re-allocation of radio resources can be implemented in a number of various embodiments based on what conditions are to be met concerning the retransmissions.

In addition to the reduction of rank in the re-transmission, different retransmissions can choose different ranks to approach spatial domain hopping in HARQ as well. Referring to above description, the extreme case is the rank-1 retransmission with spatial domain hopping in different re-transmission tries.

According to one specific embodiment, the re-allocation of radio resources enables the re-assignment of pilot space. Therefore, to take full advantage of the dimension left by the successful data streams, it is possible to re-assign the pilot space such as to further enhance the accuracy of channel estimation for the remaining links or reduce the overhead.

A further embodiment concerns allocating the available radio resources as represented by transmission power to the remaining data stream(s) to boost the signal-to-noise ratio. Furthermore, the extra dimension can be reused as a source of spatial diversity for remaining data streams. In other words, when horizontally coded data streams was partially received, the H-ARQ retransmission of the successful streams stops and the H-ARQ retransmission of the remaining streams may switch from spatial multiplexing to space-time transmit diversity by using the released dimensions in the signal space.

In the case of aggregate ACK, when all data streams are successfully received, the transmitter will be acknowledged to stop retransmission. In the case of vertical coding and spatial diversity, one data stream is separated into several parallel streams with only one CRC, which is called as per-TTI HARQ. Before receiving the aggregate ACK, the transmitter cannot distinguish if all or part of the links is in error. Instead of retransmitting on all MIMO links, the transmitter may select only part of them for retransmission.

Firstly, the selection can be based on the delayed MIMO-branch CQI feedback corresponding to the failed previous transmission with re-allocated pilot pattern and transmission power. The reallocation of pilots can follow a predetermined order of patterns a prior known to the receiver or can be signaled by the transmitter for the retransmissions,

Secondly, the selection can be based on taking into account that the systematic bits are most important in decoding, thus always retransmit the systematic bits first with reduced rank(s).

Thirdly, in another embodiment, the transmission can be reduced to a single-input multiple-output (SIMO) system after concatenating the parallel data streams back to a serial one, with full pilot and power allocation.

Fourthly, the selection of the subset of MIMO links can be performed in a random manner, e.g., spatial domain hopping, to reach the spatial domain diversity.

The above disclosed embodiments can be either used individually or jointly. One who is skilled in the art can easily generalize the spatial domain hopping to a combination of spectral, temporal, and spatial-code domain hopping schemes. In the present disclosure this generalized method signal will be referred to as space hopping.

After the reduced-rank MIMO HARQ retransmission and successful decoding of the corresponding data stream, the receiver may use decision feedback to reconstruct a “new pilot sequence” for the very branch in the soft values buffered from the last failed transmission of combined MIMO signals. The new pilot sequence based on decision feedback will be much longer than the original one; hence, the said MIMO branch can be estimated and cancelled more accurately from the old soft values. As a result, the failed MIMO branch remaining from the last transmission can be recovered with the new interference cancellation and a better chance of successful decoding.

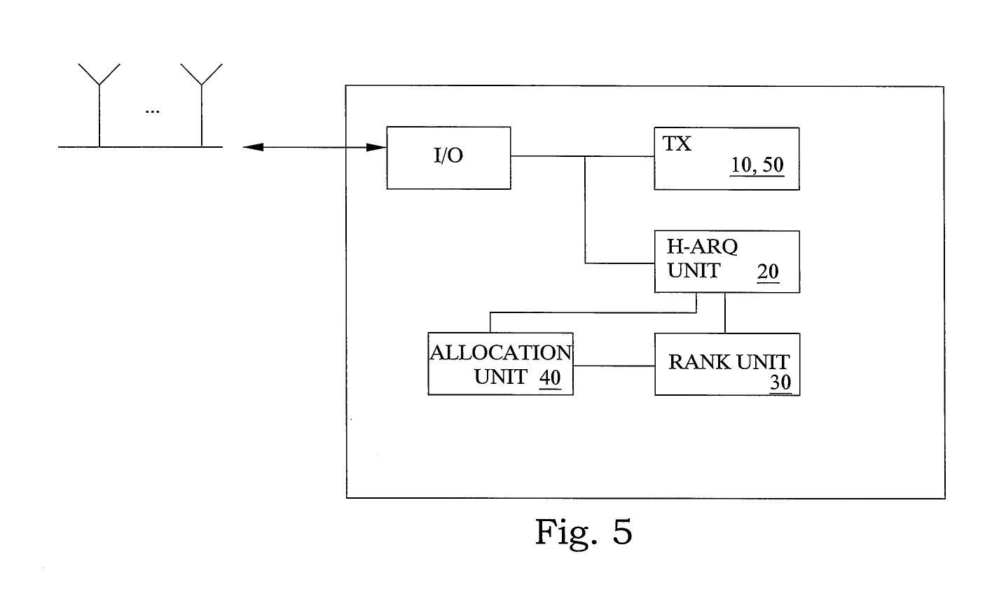

With reference to FIG. 5 a general embodiment of an arrangement according to the present invention is disclosed. The arrangement can be located in either or both of a base station or mobile terminal in a wireless communication system and comprises, in addition to an antenna array and an input output unit I/O, a transmitting unit 10, 50 adapted for transmitting data streams over one or more of the antennas in the antenna array according to a predetermined rank and radio resource allocation, a H-ARQ unit 20 adapted for receiving and processing retransmission requests relating to transmitted data, a rank processing unit 30 adapted for reducing or adapting the rank of retransmissions. The rank processing unit 30 is adapted to e.g. reducing the retransmission rank by selecting a subset of available MIMO link for retransmission of requested data streams or symbols. Further, the arrangement comprises an allocation unit 40 adapted to re-allocate the radio resources for retransmissions over the selected subset of available MIMO links. Finally, the transmitting unit 10,50 is further adapted to retransmit requested data streams or symbols based on a reduced rank and re-allocation of the radio resources.

The present invention has been described in the context of a single-user MIMO scenario; however, it is equally applicable to a multi-user MIMO scenario. Either regular multi-user MIMO (MU-MIMO) with large spaced antenna arrays (uncorrelated special channel) or so called special domain multi-access (SDMA) with closely spaced antenna arrays (correlated special channel).

In addition, instead of only utilizing the re-allocated resources for retransmissions, it is also possible to transmit new data in parallel with the re-transmitted data streams, based on the reallocated resources. Consequently, the new data streams are potentially provided with better chance of successful transmission.

### Advantages of the Invention Comprise:

Improved effectiveness in combining reduced rank MIMO HARQ with flexible resource allocation such as signal space hopping and pilot pattern reassignment, which improve the robustness against channel estimation accuracy and interference cancellation error propagation. Not only the retransmission provides extra coding diversity, or energy gains, it also improves the condition for channel estimation and interference cancellation.

It will be understood by those skilled in the art that various modifications and changes may be made to the present invention without departure from the scope thereof, which is defined by the appended claims.

### REFERENCES

[1] IEEE Std 802.16e-2005 and IEEE Std 802.16-2004/Cor1-2005 (Amendment and Corrigendum to IEEE Std 802.16-2004), “IEEE Standard for local and metropolitan area networks, Part 16: Air Interface for Fixed and Mobile Broadband Wireless Access Systems, Amendment 2: Physical and Medium Access Control Layers for Combined Fixed and Mobile Operation in License Bands,” Feb. 28, 2006.
[2] Patent application PCT/US2006/020707 “Rank Step-Down for MIMO SCW Design Employing HARQ.

1. A method of improved HARQ retransmissions of data streams in a node in a MIMO wireless communication system, characterized by transmitting S1 data across a plurality of available MIMO links according to a predetermined rank and radio resource allocation;
receiving S2 a retransmission request for at least part of the transmitted data;
reducing S3 the rank of the retransmissions by selecting a subset of the plurality of available MIMO links;
and adaptively re-allocating S4 available radio resources to said subset; and
retransmitting S5 the requested data on said selected subset according to the reduced rank and radio resource re-allocation.

2. The method according to claim 1, characterized by said re-allocation step S4 comprising one or several of reassigning pilot space, and spatial domain hopping.

3. The method according to claim 2, characterized by said data streams being horizontally coded.

4. The method according to claim 3, characterized by said re-allocation step comprising retransmitting requested data on additional MIMO links.

5. The method according to claim 3, characterized by said re-allocation step comprising switching from spatial multiplexing to space-time transmit diversity.

6. The method according to claim 2, characterized by said data streams being vertically coded.

7. The method according to claim 6, characterized by selecting one or several MIMO links for retransmission based on received CQI feedback and H-ARQ for a failed MIMO link transmission, and re-allocating pilot pattern and transmission power for said selected MIMO links.

8. The method according to claim 6, characterized by retransmitting systematic bits for requested data with reduced rank and maintaining predetermined rank and radio resource allocation for retransmission requested payload data.

9. The method according to claim 6, characterized by the further step of reducing the MIMO channel to a SIMO channel by combining all vertically coded transmitted data streams into a single serial data stream and retransmitting with full pilot and power allocation.

10. The method according to claim 6, characterized by randomly selecting the subset of MIMO links for retransmission.

11. The method according to any combination of claims 7-10.

12. The method according to claim 3, characterized by retransmitting the requested data utilizing multiple MIMO links.

13. The method according to claim 3, characterized by retransmitting the requested data utilizing the original MIMO links and increasing the allocated power for said MIMO links.

14. An arrangement in a MIMO wireless communication system, characterized by:
means 10 for transmitting data across a plurality of available MIMO links according to a predetermined rank and radio resource allocation;
means 20 for receiving a retransmission request for data;
means 30 for reducing the rank of the retransmissions by selecting a subset of the plurality of available MIMO links; and
means 40 for adaptively re-allocating available radio resources to said subset, and
means 50 for retransmitting the requested data on said selected subset according to the reduced rank and adapted the radio resource allocation.
